(19) United States
(12) Patent Application Publication
(10) Pub. No.: US 2007/0260601 A1
(43) Pub. Date: Nov. 8, 2007

(54) Distributed human improvement of search engine results

(76) Inventors: Henry S. Thompson, (US); Harry R. Halpin, Cary, NC (US)

Correspondence Address: Gearhart Law, LLC, 4 Ferndale Rd., Chatham, NJ, 07928, US

(21) Appl. No.: 11/800,149

(22) Filed: May 5, 2007

Related U.S. Application Data
(60) Provisional application No. 60/798,398, filed on May 8, 2006.

(51) Int. Cl. G06F 17/30

(52) U.S. Cl. 707/5

(57) ABSTRACT

The invention is a computer assisted method of generating query results, comprising the steps of entering a query and query criteria; submitting the query to a search engine and creating a potential result list therefrom, said potential result list having at least one result listing; constructing an annotation form, said annotation form having selectable query criteria; associating said annotation form with each result listing; allowing at least one human agent to review said result listing and select query criteria on said annotation form; ranking said result listings based on the criteria selected on said annotation form; and displaying the results to a user.

### FIELD OF THE INVENTION

The invention relates to internet technology, in particular, a process for using distributed human agents to improve the results of search engine queries.

### BACKGROUND OF THE INVENTION

The inventors have invented a process for using distributed human agents to improve the results of search engine queries. Many queries have associated criteria that can only be evaluated by human judgment. This creates a problem when querying large knowledge-bases, since determining whether a given result does or does not satisfy a particular criterion is often not in the realm of automation, even though it may be simple or even trivial for a human to determine.

The process described here allows queries and associated criteria requiring human judgement to be collected from a user. The queries are executed, and the results, along with the criteria, are processed and distributed to other human agents who are given tools to make and report their judgements in a fast and scalable manner. Their judgements are collected and integrated with the search results for post-processing and presentation to the user.

Our invention allows the user who is querying a knowledge-base to distribute the task of determining whether each result fits their criteria to one or more human agents automatically. Our process handles creating a pool of readily available and qualified human agents. These agents are then given the query and use a constrained interface that breaks down the often complex user criteria into a number of simple assessments. Our process then returns the assessed results from each agent and combines them into a final improved result to be displayed to the user. We furthermore provide an optional methodology for crediting the agent(s) based on the quality of their improved results, ensuring that the most competent and reliable agents are used by our process.

Automated search engines often return unreasonably large lists, far more than many users have time to browse through to determine if they fit their criteria. Often busy users only go through the first ten results, when often the most pertinent could be the ninetieth result. The user can waste large amounts of time browsing through these themselves, when it can often be more productive to let someone else browse and sift through the results for them, and our process provides this capability. This definitely saves the user effort, and if the human agents are fast and skilled, in some cases even time and therefore reduces cost.

Our invention also provides for the storing of information about search results determined by the human agents in the course of their assessment, for use in assisting the user, or subsequent users, to determine which result(s) to explore.

To date no-one has directly employed large-scale human improvement of query results. Our process does not directly query humans for expertise (U.S. Pat. No. 6,829,585 B1), but instead improves the results of a potentially successful search specified directly by the user.

One embodiment of this invention is illustrated in the accompanying drawings and will be described in more detail herein below.

### SUMMARY OF THE INVENTION

The present invention is a computer assisted method of generating query results, comprising the steps of entering a query and query criteria; submitting the query to a search engine and creating a potential result list therefrom, said potential result list having at least one result listing; constructing an annotation form, said annotation form having selectable query criteria; associating said annotation form with each result listing; allowing at least one human agent to review said result listing and select query criteria on said annotation form; ranking said result listings based on the criteria selected on said annotation form; and displaying the results to a user.

One advantage of the invention is that it the reduces users' effort because while retaining the flexible and subtle power of human judgment they do not have to spend their own time determining whether or not the results of their query match their requirements. Current state-of-the-art technology cannot match human judgment in determining whether a given result is appropriate to the needs of the user who initiated the query. For example, because of the large number of resources available in knowledge-bases and corpora of documents like the World Wide Web, searching by automated techniques does not usually return purely negative results or no result whatsoever, but instead returns some number of results that fit the criteria mixed with a much larger number of results that do not. Unlike U.S. Pat. No. 6,434,549, our process is not aimed at information exchange that relies on humans agents having either personal access to the knowledge or searching on for knowledge on behalf of the user, but at creating an improved list of results whether or not the criteria are knowledge-based or not. The criteria may be knowledge-based, such as whether or not a given search result contains the information that the user is seeking, or they may be based on other kinds of criteria such as the physical characteristics of the result, for example whether or not a given result can be displayed to a user on the screen of their cellular telephone. Our process discards the results that fail to meet the criteria through assessment by a human of the original query and its results, and only results that fit the criteria are displayed to the user for browsing. This “pruning” of results is an advantage to the user if they only have time to browse a few results and do not want to be distracted by unusable results. This is in contrast to prior art such as U.S. Pat. No. 5,628,011 that emphasize new automatic algorithms, such as trying to combine results automatically from multiple search engines. We exploit the fact that humans can often easily determine whether or not a given result can be assessed as fitting the criteria of a query, while computers more often fail at this task regardless of the particular algorithm employed and/or regardless of how many differing search engines are employed.

The power of human judgment can out perform automated techniques in many cases, such as detecting unwanted advertisements, web pages which are merely collections of links, material not suitable for children, and other varieties of contextually unhelpful results. These unusable results are often retrieved because of weaknesses in the automated algorithm the search engine is using or because the query terms are ambiguous or express complex information needs that are beyond the capacity of automated methods to determine. The invention combines the complementary strengths of, on the one hand, computers, to retrieve many possible results and, on the other hand, of humans, to determine quickly whether or not a web-page fits some particular criteria. This in contrast to search engines that focus on automated processes, as is the case for most current Web search engines, as exemplified by U.S. Pat. No. 5,864,846.

Another advantage of the invention is scalability and speed. Because the judgment task is split into fixed-size pieces and distributed to multiple agents, and each agent is presented with a constrained interface and a fixed size of task, human assessment is quick and scalable. Earlier efforts such as Humansearch (See Leonard, Andrew: “The Brain Strikes Back,” Salon Magazine; April 1997) and Google Answers (See Olsen, Stefanie: “Google gives some advice . . . for a price,” CNet News; April 2002) did not scale well because their human experts had to find, synthesize, and otherwise annotate information from possibly a wide variety of sources, including their own knowledge. The single expert was given a nearly infinite number of possibly difficult choices. Many systems based on human experts require a good deal of expertise in phrasing the answers or creating annotations in natural language. Instead, since our process restricts the choices made by our human agents, the task of human assessor is simply to discriminate whether each result fits the particular criteria given by the user, or to annotate each result with respect to certain simple properties, instead of paraphrasing or synthesizing information. In contrast to prior art, this efficient method of identifying, annotating and/or ranking results that fit the needed criteria can be accomplished quickly and often by non-experts.

The modularity of the method enables the use of redundancy to provide quality control. Multiple agents can be given the same subset of the results to assess, their annotations compared and under-performing agents identified.

Another advantage of the invention is that its results resemble the results given by traditional search engines, but much improved because they include only those results which have been judged by a human to fit the user's criteria. Prior art often involved interfaces far removed from traditional search engine interfaces, such as chatting with an expert as given in U.S. Pat. No. 6,745,178. While our interface does give the user the ability to specify their criteria with much greater precision than ordinary search engines, like automated search engines our process returns an easy-to-use list of results. Since unwanted results are subtracted from the results of the automated query, the improved list of results returned by our invention has the advantage of being smaller than the list returned by a fully automated search engine while still being presented in the format users are accustomed to using.

### BRIEF DESCRIPTION OF THE DRAWINGS

FIG. 1 is a flow chart illustrating the operating environment of present invention.

FIG. 2 is a flow chart illustrating a system and process for using distributed human agents to improve the results of search engine queries.

FIG. 3 is a flow chart illustrating a continuation of FIG. 2—the system and a process for using distributed human agents to improve the results of search engine queries.

FIG. 4 is a flow chart illustrating a continuation of FIG. 2 and 3—the system and a process for using distributed human agents to improve the results of search engine queries.

### DESCRIPTION OF THE PREFERRED EMBODIMENTS

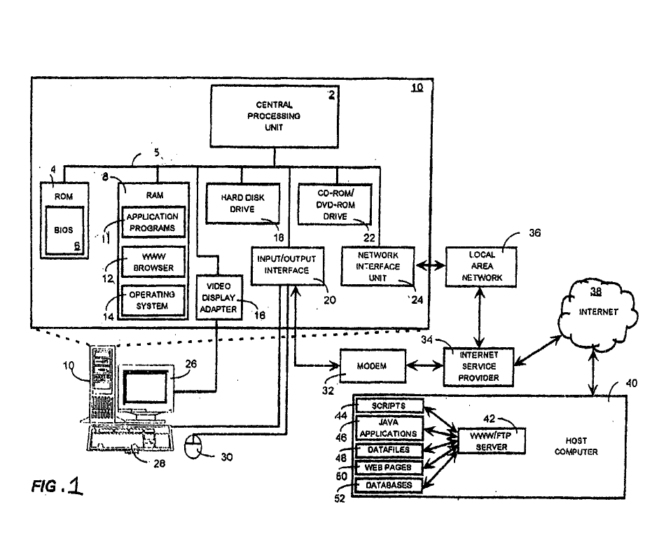

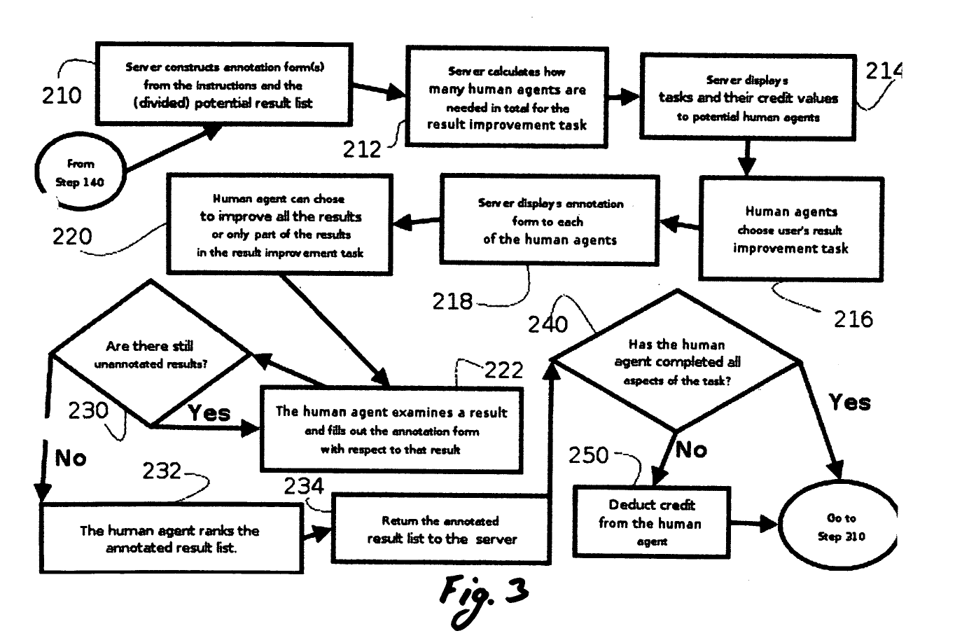

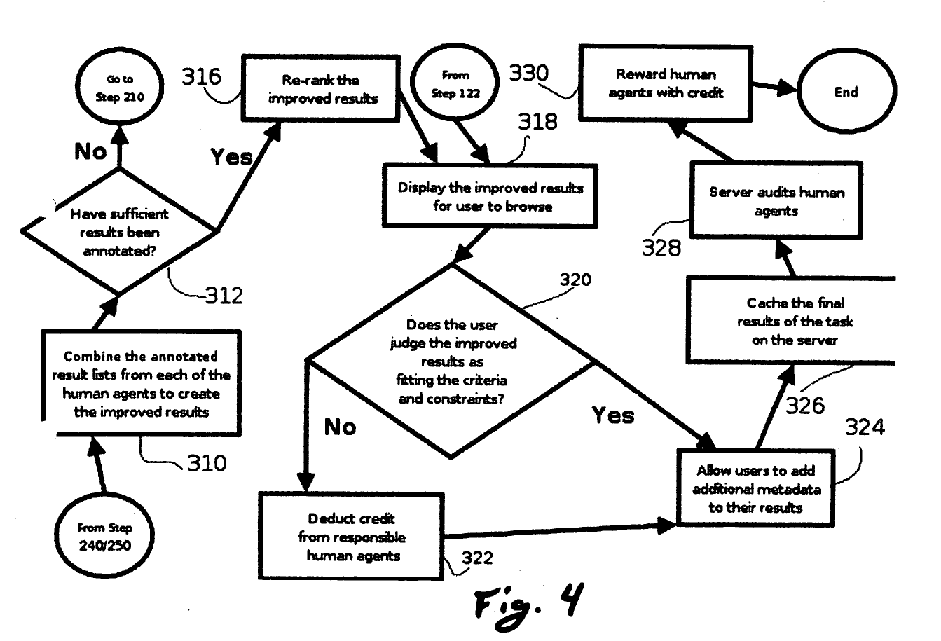

The preferred embodiments of the present invention will now be described with reference to FIG. 1-4 of the drawings.

Reference will now be made in detail to embodiment of the present invention.

Such embodiments are provided by way of explanation of the present invention, which is not intended to be limited thereto. In fact, those of ordinary skill in the art may appreciated upon reading the present specification and viewing the present drawings that various modifications and variations can be made thereto.

Although the illustrative embodiment will be generally described in the context of an application program running on a personal computer, those skilled in the art will recognize that the present invention may be implemented in conjunction with operating system programs or with other types of program modules for other types of computers. Furthermore, those skilled in the art will recognize that the present invention may be implemented in a stand-alone or in a distributed computing environment. In a distributed computing environment, program modules may be physically located in different local and remote memory storage devices. Execution of the program modules may occur locally in a stand-alone manner or remotely in a client server manner. Examples of such distributed computing environments include local area networks and the Internet.

The detailed description that follows is represented largely in terms of processes and symbolic representations of operations by conventional computer components, including a processing unit (a processor), memory storage devices, connected display devices, and input devices. Furthermore, these processes and operations may utilize conventional computer components in a heterogeneous distributed computing environment, including remote file servers, compute servers, and memory storage devices. Each of these conventional distributed computing components is accessible by the processor via a communication network.

The processes and operations performed by the computer include the manipulation of signals by a processor and the maintenance of these signals within data structures resident in one or more memory storage devices. For the purposes of this discussion, a process is generally conceived to be a sequence of computer-executed steps leading to a desired result. These steps usually require physical manipulations of physical quantities. Usually, though not necessarily, these quantities take the form of electrical, magnetic, or optical signals capable of being stored, transferred, combined, compared, or otherwise manipulated. It is convention for those skilled in the art to refer to representations of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer.

It should also be understood that manipulations within the computer are often referred to in terms such as creating, adding, calculating, comparing, moving, receiving, determining, identifying, populating, loading, executing, etc. that are often associated with manual operations performed by a human operator. The operations described herein are machine operations performed in conjunction with various input provided by a human operator or user that interacts with the computer.

In addition, it should be understood that the programs, processes, methods, etc. described herein are not related or limited to any particular computer or apparatus. Rather, various types of general purpose machines may be used with the program modules constructed in accordance with the teachings described herein. Similarly, it may prove advantageous to construct a specialized apparatus to perform the method steps described herein by way of dedicated computer systems in specific network architecture with hard-wired logic or programs stored in nonvolatile memory, such as read-only memory.

Referring now to the drawings, aspects of the present invention and the illustrative operating environment will be described.

FIG. 1 and the following discussion are intended to provide a brief, general description of a suitable computing environment in which the invention may be implemented. Referring now to FIG. 1, an illustrative environment for implementing the invention includes a conventional personal computer 10, including a processing unit 2, a system memory, including read only memory (ROM) 4 and random access memory (RAM) 8, and a system bus 5 that couples the system memory to the processing unit 2. The read only memory (ROM) 4 includes a basic input/output system 6 (BIOS), containing the basic routines that help to transfer information between elements within the personal computer 10, such as during start-up. The personal computer 100 further includes a hard disk drive 18 and an optical disk drive 22, e.g., for reading a CD-ROM disk or DVD disk, or to read from or write to other optical media. The drives and their associated computer-readable media provide nonvolatile storage for the personal computer 10. Although the description of computer-readable media above refers to a hard disk, a removable magnetic disk and a CD-ROM or DVD-ROM disk, it should be appreciated by those skilled in the art that other types of media are readable by a computer, such as magnetic cassettes, flash memory cards, digital video disks, Bernoulli cartridges, and the like, may also be used in the illustrative operating environment.

A number of program modules may be stored in the drives and RAM 8, including an operating system 14 and one or more application programs 11, such as a program for browsing the world-wide-web, such as WWW browser 12. Such program modules may be stored on hard disk drive 18 and loaded into RAM 8 either partially or fully for execution.

A user may enter commands and information into the personal computer 10 through a keyboard 28 and pointing device, such as a mouse 30. Other control input devices (not shown) may include a microphone, joystick, game pad, satellite dish, scanner, or the like. These and other input devices are often connected to the processing unit 10 through an input/output interface 20 that is coupled to the system bus, but may be connected by other interfaces, such as a game port, universal serial bus, or firewire port. A display monitor 26 or other type of display device is also connected to the system bus 5 via an interface, such as a video display adapter 16. In addition to the monitor, personal computers typically include other peripheral output devices (not shown), such as speakers or printers. The personal computer 100 may be capable of displaying a graphical user interface on monitor 26.

The personal computer 10 may operate in a networked environment using logical connections to one or more remote computers, such as a host computer 40. The host computer 40 may be a server, a router, a peer device or other common network node, and typically includes many or all of the elements described relative to the personal computer 10. The LAN 36 may be further connected to an internet service provider 34 (“ISP”) for access to the Internet 38. In this manner, WWW browser 12 may connect to host computer 40 through LAN 36, ISP 34, and the Internet 38. Such networking environments are commonplace in offices, enterprise-wide computer networks, intranets and the Internet, and are connected to the LAN 36 through a network interface unit 24. When used in a WAN networking environment, the personal computer 10 typically includes a modem 32 or other means for establishing communications through the internet service provider 34 to the Internet. The modem 32, which may be internal or external, is connected to the system bus 105 via the input/output interface 20. It will be appreciated that the network connections shown are illustrative and other means of establishing a communications link between the computers may be used.

The operating system 14 generally controls the operation of the previously discussed personal computer 100, including input/output operations. In the illustrative operating environment, the invention is used in conjunction with Microsoft Corporation's “Windows 98” operating system and a WWW browser 12, such as Microsoft Corporation's Internet Explorer or Netscape Corporation's Internet Navigator, operating under this operating system. However, it should be understood that the invention can be implemented for use in other operating systems, such as Microsoft Corporation's “WINDOWS 3.1,” “WINDOWS 95”, “WINDOWS NT” , “WINDOWS 2000”, “WINDOWS XP”, and “WINDOWS VISTA” operating systems, IBM Corporation's “OS/2” operating system, SunSoft's “SOLARIS” operating system used in workstations manufactured by Sun Microsystems, “LINUX” and the operating systems used in “MACINTOSH” computers manufactured by Apple Computer, Inc. Likewise, the invention may be implemented for use with other WWW browsers known to those skilled in the art.

Host computer 40 is also connected to the Internet 38, and may contain components similar to those contained in personal computer 10 described above. Additionally, host computer 40 may execute an application program for receiving requests for WWW pages, and for serving such pages to the requestor, such as WWW server 42. According to an embodiment of the present invention, WWW server 42 may receive requests for WWW pages 50 or other documents from WWW browser 12. In response to these requests, WWW server 42 may transmit WWW pages 50 comprising hyper-text markup language (“HTML”) or other markup language files, such as active server pages, to WWW browser 12. Likewise, WWW server 42 may also transmit requested data files 48, such as graphical images or text information, to WWW browser 12. WWW server may also execute scripts 44, such as CGI or PERL scripts, to dynamically produce WWW pages 50 for transmission to WWW browser 12. WWW server 42 may also transmit scripts 44, such as a script written in JavaScript, to WWW browser 12 for execution. Similarly, WWW server 42 may transmit programs written in the Java programming language, developed by Sun Microsystems, Inc., to WWW browser 12 for execution. As will be described in more detail below, aspects of the present invention may be embodied in application programs executed by host computer 42, such as scripts 44, or may be embodied in application programs executed by computer 10, such as Java applications 46. Those skilled in the art will also appreciate that aspects of the invention may also be embodied in a stand-alone application program.

Our invention is a process for improving search engine results and is not dependent on any particular search engine, since our process only requires the search engine to produce a list of possible results when given a query. The server is the computer program(s) and any additional support that manages the improvement of search results and mediates the interaction between the user, the search engine and the human agents that carry out the improvement. The human agents are any humans that register with the server to improve results, possibly in return for some form of credit. So our server implements the crucial function of providing an interface and process to connect the user with a pool of readily available and qualified human agents in order to improve search engine results. After each task, our server may audit the performance of the human agents in order to assess the quality of their work, and then requalify or disqualify a human agent based on this audit and a record of their past performance. Our best mode embodiment consists of using as the knowledge-base the World Wide Web and a Web-based search engine. The results of a search engine are web pages given as a list containing the URI (Uniform Resource Identifiers) of a result and possibly a fragment of summary text. This allows an agent to access and assess the contents of the result, mediated by the server and annotated with a number of constrained options to record their assessment.

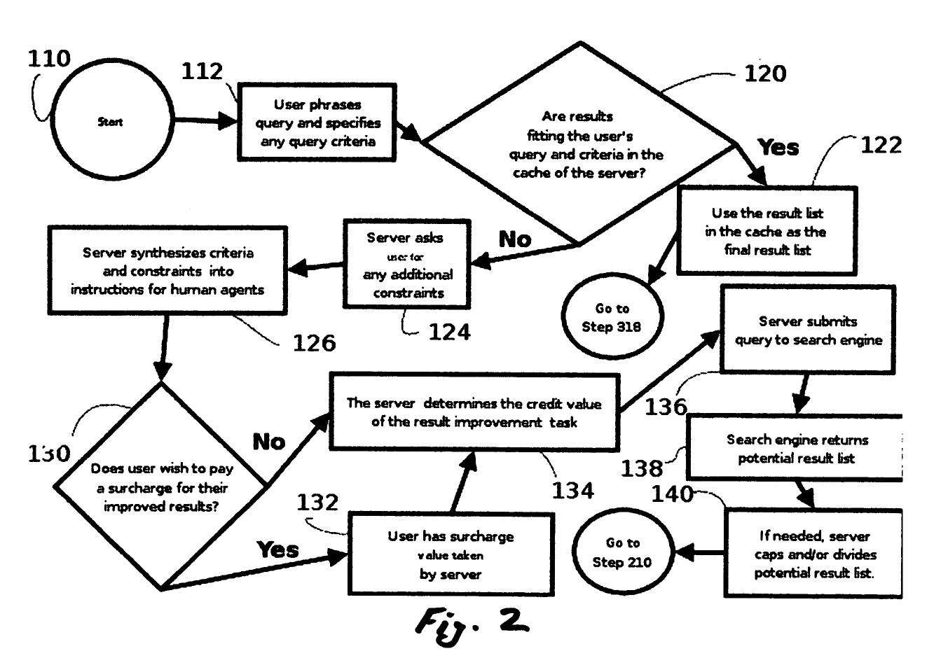

The following detailed description refers to steps in FIGS. 2 through 4. In Step 110, the process begins with a user with a need that they believe can be fulfilled by some results that are available in a knowledge-base, such as the Web, and who intends to use our server to get improved results for their search. In Step 112, the user phrases a query in the form of one or more natural language terms for a search engine. These query terms serve as part of the criteria and our interface also allows a user to specify in more detail additional and more precise criteria. These criteria specify what results would qualify as improved results. By “results” it is meant either summary results, i.e. the listing of results received from the search engine, or the combination of the results received from the search engine and the actual pages associated therewith.

Thus, a menu can be presented to the user allowing them to select criteria as results that “are not advertisements” or “are suitable for viewing by children” or “provide definitions” or “are from well-known/trusted sources.38 In the optional Step 120, the server determines if the query and criteria sufficiently match human-improved results from previous searches that have been cached. In this case, in optional Step 122 the user has the option of accepting the results that are in the cache. If this is the case, the server uses the cached results as the improved results in the process, and skips to Step 318, although from there on any steps involving credit may be not taken. If the results are not cached on the server or the cache is not used, in Step 124 (optional) the server asks for any additional constraints for the task. These constraints are not the criteria for each individual improved result as given in Step 112, but constraints for the entire result improvement task itself, such as the maximum time the task must be completed in or the knowledge bases or search engines to be queried or the minimum number of improved results that the user wants. In Step 126 the server combines the query, the criteria, and any additional data needed by the human agents, such as the date and time of the user request, to create the instructions for the result improvement task.

Then in Step 130 (optional) the user specifies if they are to pay an additional surcharge of credit for the completion of the result improvement task. Since the server would then present the result improvement tasks to human agents, an additional surcharge would encourage human agents to prioritize filtering the search results of the particular user. Note that for some embodiments of this process the surcharge may be mandatory, and in others not possible at all. If the user answers “Yes,” then in the optional Step 132 the server proceeds if necessary to take the details of the user and the exact value of the surcharge so that it may be taken into consideration in Step 134. Then in Step 134 the server determines the credit, which may be nothing, to be given to the human agents for completing an assessment for the result improvement task of the user.

Then in Step 136 the server submits the query to one or more search engines with respect to one or more knowledge bases. In Step 138 the search engines return a list of potential results. In Step 140, if the numbers of potential results are of such kind or size that the server determines it would be beneficial to have the single potential result list divided among multiple human agents, then the server may cap and/or divide the potential result list into smaller portions for distribution to human agents.

In Step 210 the server constructs annotation forms by annotating the potential result list(s) with the criteria that the user has specified. In our best mode embodiment, this would consist of adding to each result in the potential result list the options needed to assess the potential result with regard to each of the possible values of the criteria given by the user through input mechanisms such as radio buttons and check boxes. For example, if the user wants to find only video files, a simple check-box would be added to the annotation form to allow the agent to denote whether the result is a video file or not. If, in addition the user wanted the results to be rated for relevance as to whether they were about hurricanes, a control with an appropriate range of relevance options could be added to the annotation form. These input mechanisms on the annotation form will be used by the human agents to record their assessments of each result. In Step 212, the server determines how many human agents are needed in total for the entire result improvement task, taking into account any division of the task into smaller portions and the amount of redundancy required to provide for quality assurance. In Step 214, the server announces the tasks and the credit reward to the pool of human agents, indicating how many agents are wanted for each task. In Step 216, one or more human agents chooses one of the tasks. Note that each such task, as explained in Step 140, may only cover a portion of the original potential result list returned by search engine. The server will offer the tasks until the requisite number of human agents have chosen each task, although it will allow the agents to improve the results asynchronously. In a simplified example, if five hundred results were returned, and the user wants twenty improved results, the server may automatically divide the list into five groups of one hundred results, and then fifteen agents might be needed, three for each group of results, with the agreement among the three agents to be used as a method of auditing their quality. Therefore, the server will continue to offer the tasks until fifteen agents have signed up. In Step 218, the appropriate annotation form is displayed to each of the human agents that chose the corresponding task in Step 216. Note that from Step 220 up until Step 250 there may be multiple human agents following the process in parallel, although from Step 220 to Step 250 we will refer to “the human agent” as one of the agents committed to this process.

Step 222 signals the beginning of the process, encompassing Step 222 through Step 230, of examination by the human agents of each entry in the annotation form. In Step 222, for each unannotated result, the human agent uses the annotation form to record the assessment regarding the criteria given by the user. As given by Step 230, the human agent continues this until there are no unannotated results (or, as noted in Step 220, they may choose to perform only a subset of the annotations). For example, if the user is looking for web pages relevant to a certain subject, a web page may be marked as either relevant or irrelevant to the subject in the criteria via a checkbox in the annotation form. To determine this the human agent may be presented with the summary text alone, or may have access to the contents that can be accessed via the URI.

Optionally in Step 232 the human agent may then rank the annotated result list. The completed annotation form is then returned to the server in Step 234. In Step 240, the server determines whether or not the human agent has completely filled in the annotation form. If not (a “No” to Step 240), in optional Step 250 credit is deducted from the human agent. Then in Step 310 the server combines the annotated result lists from each of the human agents who chose the user's result improvement task. The server takes into account variance or discrepancies in the human agent's annotations about whether or not particular results fit the user's criteria. Also, if the original potential result list was divided into portions for the human agents (in Step 140), the server combines the results from each human agent who chose the task. In Step 312, the server determines if, for any reason, there are insufficient results of the necessary quality. If so, it returns to Step 210 to construct new annotation forms and recruit further human agents to make up the necessary additional results. The improved results are then optionally re-ranked in Step 316 by the server, again taking into account any variance or discrepancies in the rankings of the human agents. Then the improved results are displayed for the user to browse in Step 318. Note that the server may incorporate advertisements and other data in the display of the improved results.

In optional Step 320, the user may then be given the opportunity to judge whether or not the results in the improved results are satisfactory and whether or not the task constraints have been fulfilled, and this is reported to the server. In this step, the user may judge whether or not each of the improved results actually fulfills their criteria. If the user judges the improved results to be less than fully satisfactory or their task constraints not fulfilled, as given by “No” at Step 320, in the optional Step 322, the credit given to the responsible human agent can be reduced. For example, one of the human agents may have returned a result that does not to the user fulfill the criteria, and this result was put in the improved results by the server. If the user notifies the server that this result did not fit the criteria, since the server records which human agent or agents was responsible for the incorrect annotation in the improved results, it will deduct credit those agents. The user can also tell the system if they believe their constraints were not met. In another example, a human agent could be too slow in annotating the results, and so also lose credit. This information is used by server to audit the human agents in order to maintain a high quality pool of human agents and to bar unsatisfactory agents from participating in the process.

In Step 324, optionally the users may add additional metadata, such as the use of natural language tags or commentary, to their result list. Then in optionally Step 326 the server can cache the improved results and any optional or necessary metadata, taking into account whether or not the user was satisfied by the results. Then in the optional Step 328, taking any deductions given in Steps 250 and 322 into account, the server audits the human agents that performed the result improvement task in order to determine their suitability for participating in the result improvement process on another occasion. Finally, in the optional Step 330 the human agents are rewarded with credit if they qualify and the process ends.

When one of the criteria, perhaps the only one, that a search result must satisfy to be useful is that it be suitable for delivery via a particular medium or device, such as a small screen, a low-bandwidth connection or a screen-reader, an alternative embodiment of the invention is appropriate, in which 1) preparation of material for the human agents includes simulating the effects of the required medium and/or device and 2) bulk processing of popular queries is done using the techniques described above but without individual user input, with the results made available via a portal. For example, this embodiment might be used to provide a portal with up-to-date mobile-phone-suitable search results for the top 1000 celebrity names.

Hierarchical link directories are an alternative to search engines for users seeking information about particular subjects. Creating and maintaining such directories is difficult and expensive. An alternative embodiment of the invention addresses this problem by (semi-)automatically generating queries from planned or existing directory path names and using human agents nominated by the directory owner in the procedure described above.

Although this invention has been described with a certain degree of particularity, it is to be understood that the present disclosure has been made only by way of illustration and that numerous changes in the details of construction and arrangement of parts may be resorted to without departing from the spirit and the scope of the invention.

We claim:

1. A computer assisted method of generating query results, comprising the steps of:
entering a query and query criteria;
submitting the query to a search engine and creating a potential result list therefrom, said potential result list having at least one result listing;
on a server, constructing an annotation form, said annotation form having selectable query criteria;
associating said annotation form with each result listing;
allowing at least one human agent to review said result listing and select query criteria on said annotation form;
ranking said result listings based on the criteria selected on said annotation form; and
displaying the results to a user.

2. The method of claim 1, wherein the query and query criteria are entered by a user.

3. The method of claim 1, comprising the additional step of comparing the user's query and query criteria to a previous query and query criteria, and if the user's query and query criteria are the same as the previous query and criteria, then displaying results from the previous query and query criteria to a user.

4. The method of claim 1, comprising the additional step of synthesizing criteria and constraints into instructions for human agents.

5. The method of claim 4, comprising the additional step of asking the user if the user wants to pay an additional surcharge for their improved results.

6. The method of claim 1, wherein the server caps or divides the potential result list.

7. The method of claim 1, comprising the additional step of calculating the number of human agents needed to review said result list.

8. The method of claim 6 wherein the divided result list is submitted to more than one human agent.

9. The method of claim 1, comprising an additional step of calculating a credit value for a human agent for improving the result list and crediting the human agent after a satisfactory improvement of part or all of said result list.

10. The method of claim 1, wherein the annotated result list is ranked based on said criteria.

11. The method of claim 1, wherein the results are ranked by a human agent.

12. The method of claim 1, wherein the human agent repeats the step of reviewing said result listing and selecting the query criteria until all or part of the result list is exhausted.

13. The method of claim 9, wherein credit is deducted if the improvement of the result list is not satisfactory.

14. The method of claim 8, wherein the result from more than one human agent are combined.

15. The method of claim 1, comprising the additional step of determining whether a sufficient number of result listings have been reviewed.

16. The method of claim 1, comprising the additional step of allowing the user to determine if the results fit the query criteria.

17. The method of claim 1, comprising the additional step of allowing the user to add additional query criteria after the results are displayed.

18. The method of claim 1, wherein the results are intended for delivery via a particular medium, and presentation of the result via that medium is simulated for the human agent to assess.

19. The method of claim 1, wherein the queries are generated automatically based on a link directory hierarchy, and human agents are supplied by the directory owner.

20. The method of claim 1, wherein the queries are derived automatically from a tabulation of frequent queries.

21. The method of claim 1, wherein results are restricted to material within an institution, and the human agents are employees of that institution.
